(19) United States
(12) Patent Application Publication
(10) Pub. No.: US 2013/0058624 A1
(43) Pub. Date: Mar. 7, 2013

(54) NETWORK CONTROL DEVICE, DISPLAY DEVICE, AND NETWORK CONTROL METHOD

(71) Applicant: Kenji TSUNASHIMA, Tokyo (JP)

(72) Inventor: Kenji TSUNASHIMA, Tokyo (JP)

(21) Appl. No.: 13/562,866

(22) Filed: Jul. 31, 2012

(30) Foreign Application Priority Data
Sep. 2, 2011 (JP) 2011-191616

(51) Int. Cl. H04N 5/765; H04W 80/00; G09G 5/00

(52) U.S. Cl. 386/234; 345/156

(57) ABSTRACT

A user-operable device and a display device are connected via a network. The user-operable device has a user interface that involves display of user interface images on the display device. A network control device connected to the network stores surrogate user interface image data. Before the user interface of the user-operable device becomes operational, the network control device displays a surrogate user interface on the display device and receives events generated by user operations from the display device. The network control device transfers the received events to the user-operable device after the user interface of the user-operable device becomes operational.

### BACKGROUND OF THE INVENTION

1. Field of the Invention

The present invention relates to a network control device and display device that control a user-operable device through a network, and to a network control method.

2. Description of the Related Art

With the spread of digital broadcasting, digital video recording at home has become more common, and it has become easier to construct systems for transmitting, receiving, recording, and reproducing digital video signals by networking digital broadcast receivers with hard disk drive (HDD) recorders, digital versatile disc (DVD) recorders, and other video recording and reproducing devices.

Compared with a traditional analog broadcast receiver, a digital broadcast receiver includes more software-controlled components, so it generally utilizes an operating system (OS). Accordingly, after a digital broadcast receiver is powered on, the OS has to start up and it takes some time before a video picture can be displayed. This is also true of video recording and reproducing devices: before the device can be operated, it is necessary to wait for the OS to start up.

The recording and reproducing device disclosed by Maeda et al. in Japanese Patent Application Publication No. 2007-115295 reduces the length of the wait for the device to become ready to operate by providing, in addition to a power saving low-power mode, a quick activation mode in which the device goes into a standby state but continues supplying power to its hard disk drive.

A broadcast receiver disclosed by Mizuguchi in Japanese Patent Application Publication No. 2009-088737 likewise provides both a low-power standby mode and a quick start mode in which more components are powered than in the standby mode, thereby reducing the length of the wait until the user can operate the device.

In both of these devices, however, there is still a wait from exiting the quick activation or quick start mode until completion of the start-up process. There is also a long standby time before the device becomes ready to operate when it recovers from the low-power mode, which conserves more power than the quick start or quick activation mode, and when the device starts up from the power-off state.

### SUMMARY OF THE INVENTION

An object of the present invention is to shorten the standby time until a user-operable device becomes ready to operate.

The invention provides a novel network control device including a screen control information storage unit that stores screen control information including user interface image data for operation of a user-operable device, and a communication section for transmitting information to and receiving information from a network. The network control device also includes a transfer processing unit, a receiving processing unit, and a device status supervision unit.

The device status supervision unit supervises the user-operable device and decides whether the user-operable device is able to provide its own user interface.

When the user-operable device is unable to provide its own user interface, the transfer processing unit performs a transmitting process in which it transmits the user interface image data via the communication section to a display device connected to the network, and a receiving process in which it receives, from the display device, one or more events occurring in a user interface based on the user interface image data. After this, the receiving processing unit performs a transfer process in which it transfers the received events via the communication section to the user-operable device.

The novel network control device thereby provides a surrogate user interface that enables the user to begin operating the user-operable device even before the user-operable device is able to provide its own user interface.

The invention also provides a novel display device with similar features for providing a surrogate user interface.

### BRIEF DESCRIPTION OF THE DRAWINGS

In the attached drawings:

FIG. 1 is a schematic block diagram illustrating the structure of a network system according to a first embodiment of the invention;

FIG. 2 is a schematic block diagram illustrating the structure of the network control device in FIG. 1;

FIG. 3 is a schematic block diagram illustrating the structure of the broadcast receiving device in FIG. 1;

FIG. 4 is a schematic block diagram illustrating the structure of the video recording and reproducing device in FIG. 1;

FIG. 5 is a schematic block diagram illustrating the structure of the remote control device in FIG. 1;

FIG. 6 illustrates an exemplary operational sequence in the network system in the first embodiment;

FIG. 7 is a flowchart illustrating the operation of the network control device in FIG. 1;

FIG. 8 a schematic block diagram illustrating the structure of a network system according to a second embodiment of the invention;

FIG. 9 is a schematic block diagram illustrating the structure of the broadcast receiving device in FIG. 8;

FIG. 10 illustrates an exemplary operational sequence in the network system in the second embodiment; and

FIG. 11 is a flowchart illustrating the operation of the broadcast receiving device in FIG. 8.

### DETAILED DESCRIPTION OF THE INVENTION

Embodiments of the invention will now be described with reference to the attached drawings, in which like elements are indicated by like reference characters.

### First Embodiment

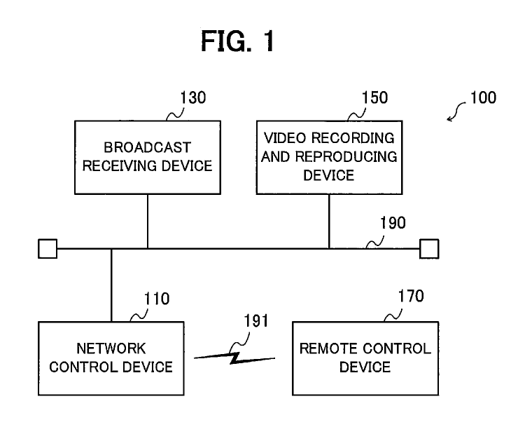

Referring to FIG. 1, the network system 100 in the first embodiment includes a network control device 110, a broadcast receiving device 130 that is an example of a display device, a video recording and reproducing device 150 that is an example of a user-operable device, and a remote control device 170 that is also an example of the display device. The network control device 110, broadcast receiving device 130, and video recording and reproducing device 150 are connected to a first network 190. The network control device 110 and remote control device 170 are connected to a second network 191. In this embodiment, the first network 190 is assumed to be a wired local area network (LAN) and the second network 191 is assumed to be a wireless LAN, but this is not a limitation; other types of networks may be used.

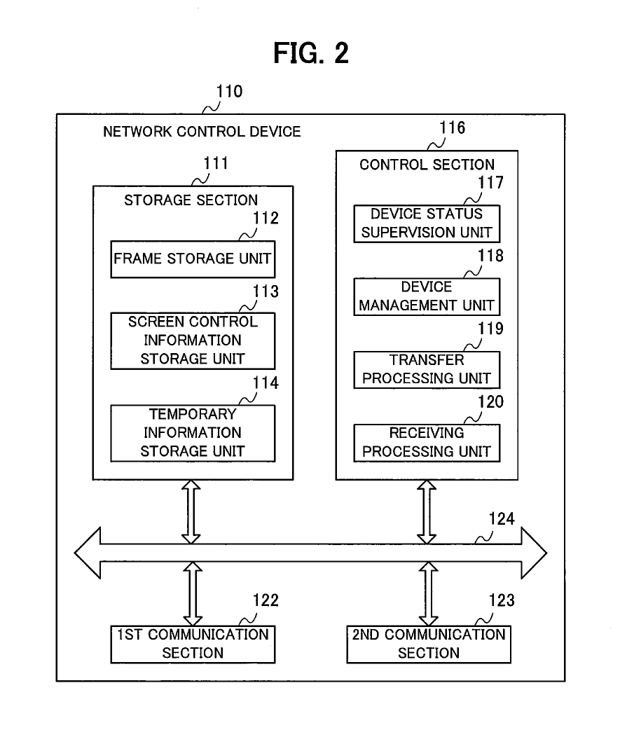

Referring to FIG. 2, the network control device 110 includes a storage section 111, a control section 116, a first communication section 122, a second communication section 123, and an internal bus 124.

The storage section 111 stores information necessary for processing carried out by the network control device 110. The storage section 111 includes a frame storage unit 112, a screen control information storage unit 113, and a temporary information storage unit 114.

The frame storage unit 112 is a memory on which bitmap data used in a user interface are loaded.

The screen control information storage unit 113 stores screen control information including bitmap data representing image data of a user interface by which the user operates the video recording and reproducing device 150, event information about events occurring in the user interface displayed by use of the bitmap data, and transition information representing interface image transitions that occur in response to the events. The user interface displayed by use of the screen control information stored in the screen control information storage unit 113 is preferably identical to the user interface displayed by the video recording and reproducing device 150 itself in order to receive user input.

The temporary information storage unit 114 stores information that is required temporarily in the processing executed by the control section 116. In this embodiment, for example, the temporary information storage unit 114 stores event occurrence information representing events that occur before the video recording and reproducing device 150 can provide its own user interface. Events are stored in chronological order, i.e., in the order in which they occur.

The control section 116 includes a device status supervision unit 117, a device management unit 118, a transfer processing unit 119, and a receiving processing unit 120.

The device status supervision unit 117 monitors the status of the other devices connected to the first and second networks 190, 191. For example, the device status supervision unit 117 monitors the other devices connected to the first network 190 by sending them specific packets defined in the universal plug and play (UPnP) standard, or another such standard, and receiving their responses. The device status supervision unit 117 decides that another device is in the process of starting up when, for example, the receiving processing unit 120 receives user interface image data indicating that the video recording and reproducing device 150 is in the process of starting up from the device via the first communication section 122, or receives other information indicating that the device is in the process of starting up.

For brevity, user interface image data will be referred to as interface screen data or simply screen data below.

The device management unit 118 manages the video recording and reproducing device 150 according to the information obtained by the device status supervision unit 117, as follows.

For example, when the video recording and reproducing device 150 cannot provide its own user interface, the device management unit 118 causes the transfer processing unit 119 to generate surrogate interface screen data to receive commands input by the user by use of the screen control information stored in the screen control information storage unit 113, and causes the transfer processing unit 119 to send the surrogate screen data to the broadcast receiving device 130 or remote control device 170, or both. If the transfer processing unit 119 then receives an event from the broadcast receiving device 130 or remote control device 170 through the first or second communication section 122 or 123, the device management unit 118 obtains the event from the transfer processing unit 119. The device management unit 118 stores such received events in chronological order as event occurrence information in the temporary information storage unit 114. After the video recording and reproducing device 150 becomes capable of providing its own user interface, by completion of its start-up process, for example, the device management unit 118 refers to the stored event occurrence information and causes the receiving processing unit 120 to transfer the events in chronological order.

When the video recording and reproducing device 150 is able to provide its own user interface and the receiving processing unit 120 receives interface screen data from the video recording and reproducing device 150 through the first communication section 122, the device management unit 118 receives the screen data from the receiving processing unit 120 and causes the transfer processing unit 119 to transfer the received screen data to the remote control device 170 through the second communication section 123. When the transfer processing unit 119 receives an event through the second communication section 123, the device management unit 118 receives the event from the transfer processing unit 119 and causes the receiving processing unit 120 to transfer the event to the video recording and reproducing device 150 through the first communication section 122.

The device management unit 118 also carries out acquisition processing of screen control information of the video recording and reproducing device 150 connected to the first network 190. For example, when the video recording and reproducing device 150 is first connected to the first network 190, the device management unit 118 acquires from the video recording and reproducing device 150 the bitmap data that the video recording and reproducing device 150 uses to display its user interface, event information about events that occur in the user interface displayed by use of the bitmap data, and transition information representing interface screen transitions that occur in response to the events, and stores this information and data in the screen control information storage unit 113 as screen control information. Alternatively, the screen control information may be acquired by a user operation, or by transmission of a particular command to the video recording and reproducing device 150. The device management unit 118 may also acquire the screen control information by monitoring the interface screen data sent from the video recording and reproducing device 150, events sent from the broadcast receiving device 130, and interface screen data sent from the video recording and reproducing device 150 after the events occur.

On command from the device management unit 118, the transfer processing unit 119 uses the screen control information stored in the screen control information storage unit 113 to generate the screen data for the user interface by which the video recording and reproducing device 150 receives command input from the user, and sends the generated screen data to the broadcast receiving device 130 or remote control device 170, or both, through the first communication section 122 or second communication section 123, or both.

When the transfer processing unit 119 receives an event from the broadcast receiving device 130 or remote control device 170 through the first communication section 122 or second communication section 123, it passes the event to the device management unit 118. The transfer processing unit 119 refers to the screen control information, and if the received event causes a screen transition, it generates the screen data of the successor screen (the post-transition screen) and sends the generated screen data to the broadcast receiving device 130 or remote control device 170, or both, through the first communication section 122 or second communication section 123, or both.

When the receiving processing unit 120 receives screen data from the video recording and reproducing device 150 connected to the first network 190 through first communication section 122, it passes the received screen data to the device management unit 118.

On command from the device management unit 118, the receiving processing unit 120 refers to the stored event occurrence information and sends the events in chronological order through the first communication section 122.

The first communication section 122 transmits information to and receives information from the first network 190.

The second communication section 123 transmits information to and receives information from the second network 191.

The network control device 110 described above can be implemented by an embedded system equipped with a central processing unit (CPU), a storage device such as a semiconductor memory device, and one or more communication devices, such as network interface cards (NICs), for connection with communication networks.

For example, the storage section 111 can be implemented by the storage device controlled by the CPU; the control section 116 can be implemented by the CPU executing prescribed programs stored in the storage device; the first and second communication sections 122, 123 can be implemented by the communication devices controlled by the CPU.

If the network control device 110 is implemented with an embedded system in this way, a commercially available embedded CPU board can be utilized without major alteration. Accordingly, if a low-power embedded CPU board is used, power consumption can be minimized even if the network control device 110 is kept running constantly.

In this embodiment, the transfer processing unit 119 and receiving processing unit 120 in the control section 116 can be implemented easily by use of a virtual network computing (VNC) package available as open source software. In this case, the transfer processing unit 119 functions as a VNC server, and the receiving processing unit 120 functions as a VNC client. The art of the VNC is described in detail by Karasawa in Japanese Patent Application Publication No. 2005-284195.

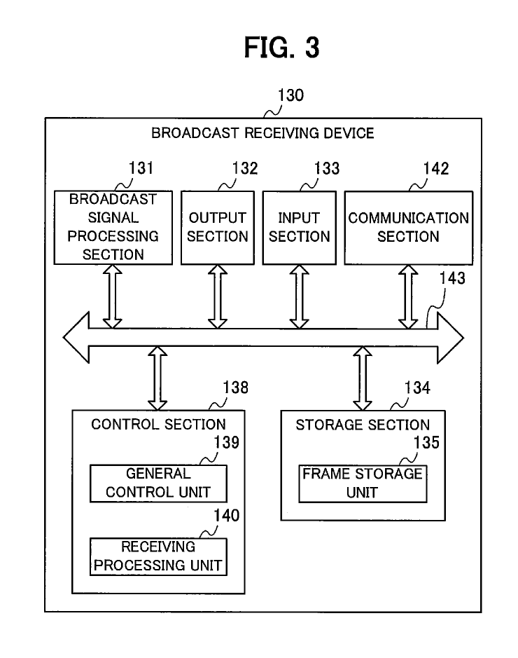

Referring now to FIG. 3, the broadcast receiving device 130 includes a broadcast signal processing section 131, an output section 132, an input section 133, a storage section 134, a control section 138, a communication section 142, and an internal bus 143.

The broadcast signal processing section 131 demodulates video data and audio data from a broadcast signal received by an antenna (not shown) or another section and sends the demodulated data to the output section 132.

The output section 132 includes a display unit such as a display panel and an audio output unit such as a speaker. Based on the audio and video data received from the broadcast signal processing section 131, the output section 132 outputs a video picture and sound. Under the control of the control section 138, the output section 132 also displays user interface screens on the basis of bitmap data loaded on the storage section 134.

The input section 133 receives commands from the user.

The storage section 134 stores information necessary for the processing carried out in the broadcast receiving device 130. In this embodiment, the storage section 134 includes a frame storage unit 135. The frame storage unit 135 is a memory on which bitmap data are loaded. In particular, the bitmap data used in the user interface are loaded on the frame storage unit 135.

The control section 138 includes a general control unit 139 and a receiving processing unit 140.

The general control unit 139 performs general supervisory control of the processing in the broadcast receiving device 130.

When the receiving processing unit 140 receives interface screen data from the video recording and reproducing device 150 or network control device 110 through the communication section 142, it loads bitmap data included in the screen data on the frame storage unit 135. The receiving processing unit 140 then causes the output section 132 to display the user interface by using the loaded bitmap data. If an event occurs by the user's performing an input operation through the input section 133 with the user interface displayed on the output section 132, the receiving processing unit 140 sends the event to the video recording and reproducing device 150 or network control device 110, or both, through the communication section 142.

The communication section 142 transmits information to and receives information from the first network 190.

The control section 138, storage section 134, and communication section 142 in the broadcast receiving device 130 can be implemented as, for example, an embedded system equipped with a CPU, a storage device such as a semiconductor memory device, and a communication device, such as, an NIC for connection with a communication network.

For example, the storage section 134 can be implemented by the storage device controlled by the CPU; the control section 138 can be implemented by the CPU executing prescribed programs stored in the storage device; the communication section 142 can be implemented by the communication device controlled by the CPU.

In this embodiment, the receiving processing unit 140 in the control section 138 can be implemented easily by use of a VNC package. The receiving processing unit 140 functions as a VNC client.

The input section 133 can be implemented in a control panel on the broadcast receiving device 130 or as a remote control device.

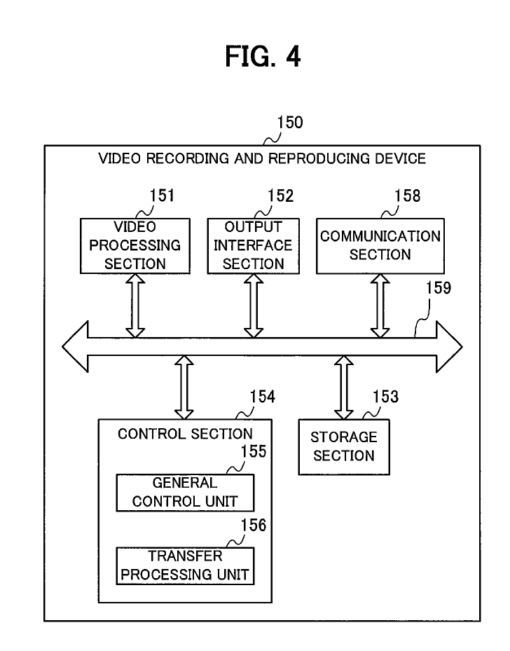

Referring to FIG. 4, the video recording and reproducing device 150 includes a video processing section 151, an output interface section 152, a storage section 153, a control section 154, a communication section 158, and an internal bus 159.

The video processing section 151 reads audio and video data from, for example, a hard disc drive (HDD), a digital versatile disc (DVD), a Blu-ray disk (BD), or another storage medium. The video processing section 151 then, in response to a command from the control section 154, has these audio and video data output through the output interface section 152 or transmitted by the communication section 158. In this embodiment, the audio and video data are output or transmitted to the broadcast receiving device 130.

The output interface section 152 is an interface through which data, including both audio and video data, are output to an external device.

The storage section 153 stores information necessary for the processing carried out in the video recording and reproducing device 150.

The control section 154 includes a general control unit 155 and a transfer processing unit 156.

The general control unit 155 performs general supervisory control of the processing in the video recording and reproducing device 150.

The transfer processing unit 156, operating on the basis of information such as the bitmap data stored in the storage section 153, generates the screen data used in the user interface for receiving command input from the user. The transfer processing unit 156 then sends the screen data to the network control device 110 or broadcast receiving device 130, or both, through the communication section 158.

When the transfer processing unit 156 receives an event from the network control device 110 or broadcast receiving device 130 through the communication section 158, it performs a process corresponding to the event. For example, when the received event causes a screen transition, the transfer processing unit 156 generates successor screen data and sends the successor screen data to the network control device 110 or broadcast receiving device 130, or both, through the communication section 158. If the received event requires control by the video processing section 151, the transfer processing unit 156 passes the event to the general control unit 155, which then carries out a control process corresponding to the event.

The communication section 158 transmits information to and receives information from the first network 190.

The storage section 153, control section 154, and communication section 158 in the video recording and reproducing device 150 can be implemented as, for example, an embedded system equipped with a CPU, a storage device such as a semiconductor memory device, and a communication device, such as an NIC, for connection with a communication network.

For example, the storage section 153 can be implemented by the storage device controlled by the CPU; the control section 154 can be implemented by the CPU executing prescribed programs stored in the storage device; the communication section 158 can be implemented by the communication device controlled by the CPU.

In this embodiment, the transfer processing unit 156 in the control section 154 can be implemented easily by use of a VNC package. The transfer processing unit 156 functions as the VNC server.

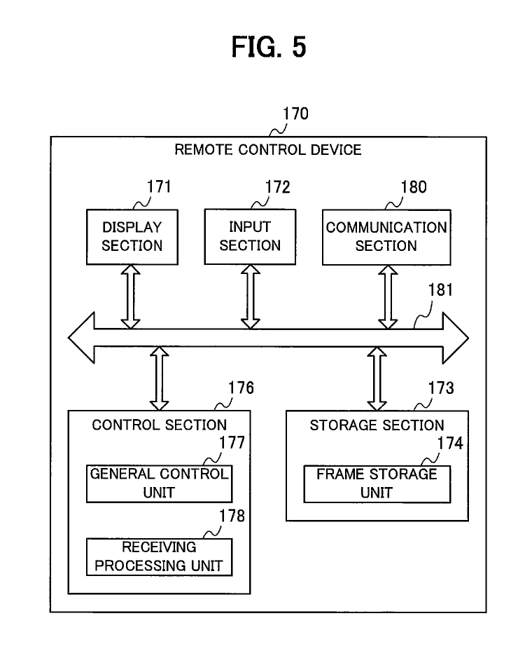

Referring to FIG. 5, the remote control device 170 includes a display section 171, an input section 172, a storage section 173, a control section 176, a communication section 180, and an internal bus 181.

The display section 171 is a display screen that displays information such as user interface information.

The input section 172 receives command input from the user.

The storage section 173 stores information necessary for the processing carried out in the remote control device 170. In this embodiment, the storage section 173 includes a frame storage unit 174.

The frame storage unit 174 is a memory on which bitmap data used for the user interface are loaded.

The control section 176 includes a general control unit 177 and a receiving processing unit 178.

The general control unit 177 performs general supervisory control of the processing in the remote control device 170.

The receiving processing unit 178 receives screen data from the network control device 110 through the communication section 180, loads bitmap data included in the screen data on the frame storage unit 174, and causes the display section 171 to display a user interface by use of the bitmap data that have been loaded on the frame storage unit 174. When an event occurs through the input section 172 in the user interface being displayed at the display section 171, the receiving processing unit 178 sends the event to the network control device 110 through the input section 172.

The communication section 180 transmits information to and receives information from the second network 191.

The storage section 173, control section 176, and communication section 180 in the remote control device 170 can be implemented as, for example, an embedded system equipped with a CPU, a storage device such as a semiconductor memory device, and a communication device, such as an NIC, for connection with a communication network.

For example, the storage section 173 can be implemented by the storage device controlled by the CPU; the control section 176 can be implemented by the CPU executing prescribed programs stored in the storage device; the communication section 180 can be implemented by the communication device controlled by the CPU.

In this embodiment, the receiving processing unit 178 in the control section 176 can be implemented easily by use of a VNC package. The receiving processing unit 178 functions as a VNC client.

The input section 172 can be implemented by, for example, buttons provided on the remote control device 170 or a touch panel integral with the display section 171.

The remote control device 170 may be a dedicated remote control device or a mobile information device such as a smart phone or an electronic tablet.

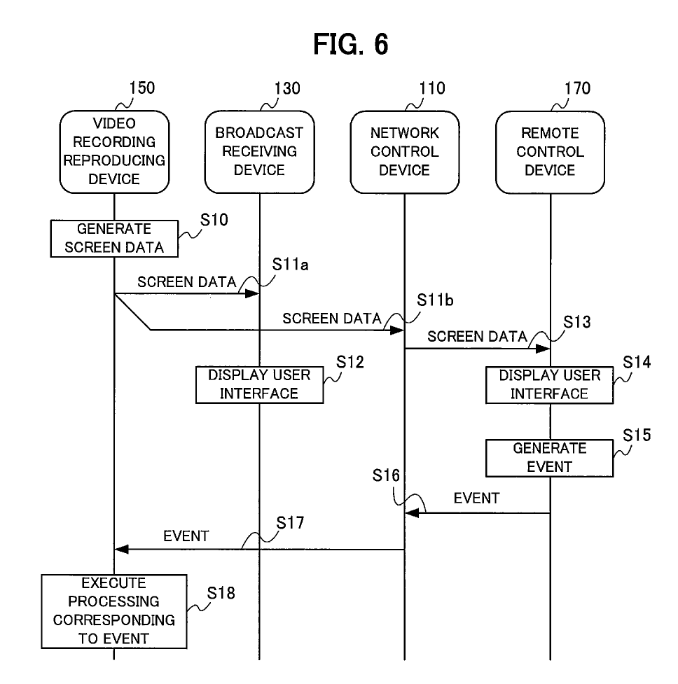

FIG. 6 illustrates an exemplary processing sequence in the network system 100. The sequence shown in FIG. 6 assumes that the network control device 110, broadcast receiving device 130, video recording and reproducing device 150, and remote control device 170 have all been activated and are ready to operate.

In the video recording and reproducing device 150, from the bitmap data and other information stored in the storage section 153, the transfer processing unit 156 generates interface screen data for receiving command input from the user (S10). The transfer processing unit 156 sends the generated screen data to the broadcast receiving device 130 and network control device 110 through the communication section 158 (steps S11a and S11b).

In the broadcast receiving device 130, the receiving processing unit 140 in the control section 138 receives the screen data through the communication section 142. The receiving processing unit 140 loads bitmap data included in the screen data on the frame storage unit 135. The receiving processing unit 140 causes the output section 132 to display the user interface by use of the bitmap data loaded on the frame storage unit 135 (step S12).

When the network control device 110 receives the screen data from the video recording and reproducing device 150, the device management unit 118 receives the screen data from the receiving processing unit 120 and issues a command to the transfer processing unit 119 to transfer the received screen data. The transfer processing unit 119 responds by transferring the received screen data to the remote control device 170 through the second communication section 123 (step S13).

In the remote control device 170, the receiving processing unit 178 in the control section 176 receives the screen data from the communication section 180. The receiving processing unit 178 loads the bitmap data included in the screen data on the frame storage unit 174. The receiving processing unit 178 causes the display section 171 to display the user interface by use of the bitmap data loaded on the frame storage unit 174 (step S14).

When the user performs an input operation through the input section 172 in the remote control device 170 and an event is thereby generated (step S15) in the user interface displayed by the display section 171, the receiving processing unit 178 sends the generated event to the network control device 110 through the communication section 180 (step S16).

In the network control device 110, the device management unit 118 receives the event from the transfer processing unit 119 and issues a command to the receiving processing unit 120 to transfer the event. The receiving processing unit 120 responds by transferring the event to the video recording and reproducing device 150 through the first communication section 122 (step S17).

In the video recording and reproducing device 150, the transfer processing unit 156 in the control section 154 receives the event from the communication section 158, and performs processing corresponding to the event (step S18).

The sequence described above shows an exemplary case in which the user uses the remote control device 170 to generate an event, but the user may use the broadcast receiving device 130 to generate an event. In that case, the receiving processing unit 140 in the broadcast receiving device 130 sends the generated event to the video recording and reproducing device 150 through the communication section 142.

When the device management unit 118 in the network control device 110 receives the screen data received in step S11b, the event received in step S16, and successor screen data generated by the video recording and reproducing device 150 in processing the event in step S18, for example, by monitoring the screen data and event it can acquire screen control information stored in the video recording and reproducing device 150.

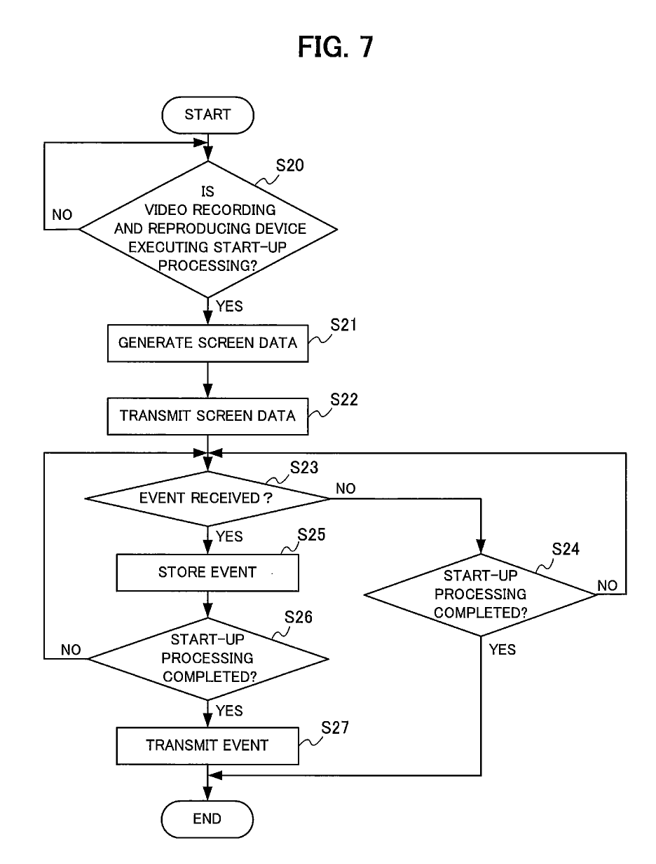

The operation of the network control device 110 when the video recording and reproducing device 150 is unable to provide its own user interface will now be described with reference to the flowchart in FIG. 7. FIG. 7 assumes that the video recording and reproducing device 150 is unable to provide its own user interface because it is currently executing start-up processing.

The device status supervision unit 117 in the network control device 110 monitors the status of the video recording and reproducing device 150. When the device status supervision unit 117 decides that the video recording and reproducing device 150 is executing start-up processing (Yes in step S20), the device management unit 118 proceeds to step S21.

In step S21, in response to a command from the device management unit 118, the transfer processing unit 119 generates interface screen data that the video recording and reproducing device 150 uses to accept command input from the user (step S21). The screen data may represent, for example, the user interface that the video recording and reproducing device 150 displays immediately after it has completed start-up processing.

The transfer processing unit 119 sends the screen data generated in step S21 to the broadcast receiving device 130 or remote control device 170, or both, by using the first communication section 122 or second communication section 123, or both (S22). For example, the device status supervision unit 117 may also monitor the status of the broadcast receiving device 130, and the transfer processing unit 119 may omit sending the screen data to the broadcast receiving device 130 if the broadcast receiving device 130 is powered off. In addition, the device status supervision unit 117 may monitor the status of the remote control device 170, and the transfer processing unit 119 may omit sending the screen data to the remote control device 170 if the remote control device 170 is powered off.

The device management unit 118 checks whether the transfer processing unit 119 has received an event through the first communication section 122 or second communication section 123 (step S23). If the transfer processing unit 119 has not received an event (No in step S23), the device management unit 118 proceeds to step S24; if the transfer processing unit 119 has received an event, the device management unit 118 proceeds to step S25.

In step S24, the device management unit 118 refers to the monitoring results in the device status supervision unit 117 to check whether the start-up of the video recording and reproducing device 150 has been completed or not. If the start-up is completed (Yes in step S24), the process ends; if the start-up is not completed (No in step S24), that is, if the video recording and reproducing device 150 is still executing start-up processing, the process returns to step S23.

In step S25, the device management unit 118 causes the temporary information storage unit 114 to store events received in step S23 in chronological order as event occurrence information.

Next, the device management unit 118 refers to the monitoring results in the device status supervision unit 117 to check whether the start-up of the video recording and reproducing device 150 has been completed or not (step S26). If the start-up is completed (Yes in step S26), the process proceeds to step S27; if the start-up is not completed (No in step S26), that is, if the video recording and reproducing device 150 is still executing start-up processing, the process returns to step S23. The video recording and reproducing device 150 becomes capable of providing its own user interface when the start-up is completed.

In step S27, the device management unit 118 refers to the event occurrence information stored in the temporary information storage unit 114 and causes the receiving processing unit 120 to send the events to the video recording and reproducing device 150 in chronological order through the first communication section 122. In the art of VNC, mouse- and keyboard-related events are generally sent to the VNC server, which executes the input operations. For keyboard-related events, information indicating which key was pressed on the VNC viewer side is sent to the VNC server; for mouse-related events, information indicating which button was pressed and indicating the cursor position on the screen at which the button was pressed is sent to the VNC server. Accordingly, if the events are stored in chronological order, the network control device 110 sends the stored events to the video recording and reproducing device 150 after the video recording and reproducing device 150 has finished starting up, and the corresponding sequence of operations is performed. Since it is necessary to switch or alter interface screens in response to events, transition information indicating a correspondence between state transitions and bitmap data is included in the screen control information.

As described above, according to this embodiment, when the video recording and reproducing device 150 is unable to provide its own user interface, the network control device 110 provides a surrogate user interface for the video recording and reproducing device 150, thereby enabling the user to perform operations even before the video recording and reproducing device 150 has finished starting up. This user interface is also sent to the remote control device 170, so even if the video recording and reproducing device 150 is not located near the broadcast receiving device 130, the user can operate the video recording and reproducing device 150 by viewing the interface on the screen of the remote control device 170.

### Second Embodiment

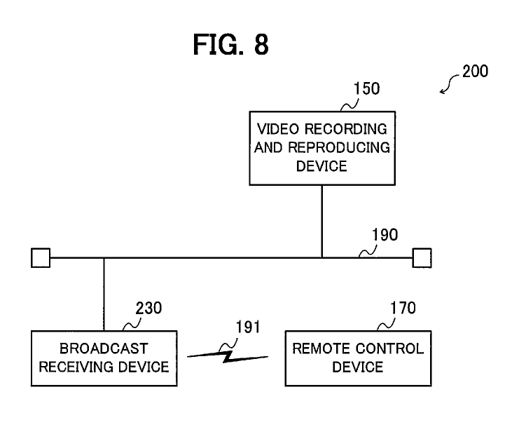

Referring to FIG. 8, the network system 200 in the second embodiment includes a broadcast receiving device 230, a video recording and reproducing device 150, and a remote control device 170 interconnected by first and second networks 190, 191. The network system 200 differs from the network system 100 in the first embodiment in the broadcast receiving device 230.

The network control device 110 used in the first embodiment is not included in the second embodiment. The processes carried out in the network control device 110 in the first embodiment are carried out in the broadcast receiving device 230 in the second embodiment.

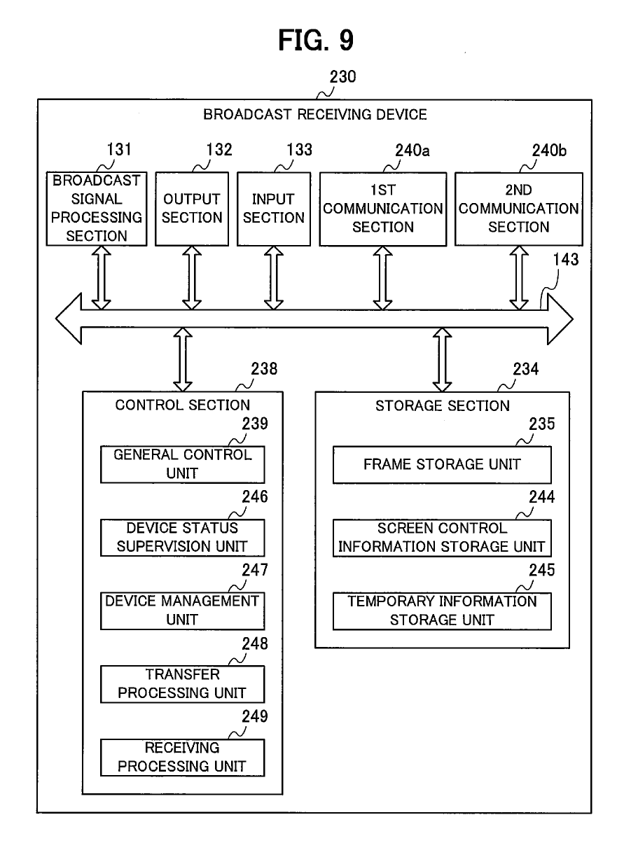

Referring to FIG. 9, the broadcast receiving device 230 includes a broadcast signal processing section 131, an output section 132, an input section 133, a storage section 234, a control section 238, a first communication section 240a, a second communication section 240b, and an internal bus 143. The broadcast receiving device 230 in the second embodiment differs from the broadcast receiving device 130 in the first embodiment in the structures of the storage section 234 and control section 238, and in that it includes two communication sections 240a, 240b.

The storage section 234 stores information necessary for processing carried out in the broadcast receiving device 230. In this embodiment, the storage section 234 includes a frame storage unit 235, a screen control information storage unit 244, and a temporary information storage unit 245.

The frame storage unit 235 is a memory on which bitmap data used in a user interface can be loaded.

The screen control information storage unit 244 stores screen control information including bitmap data representing image data of a user interface by which the user operates the video recording and reproducing device 150, event information about events occurring in the user interface displayed by use of the bitmap data, and transition information representing interface image transitions that occur in response to the events

The temporary information storage unit 245 stores information that is required temporarily in the processing executed by the control section 238. In this embodiment, for example, the temporary information storage unit 245 stores event occurrence information representing events that occur before the video recording and reproducing device 150 can provide its own user interface. Events are stored in chronological order.

The control section 238 includes a general control unit 239, a device status supervision unit 246, a device management unit 247, a transfer processing unit 248, and a receiving processing unit 249.

The general control unit 239 performs general supervisory control of the processing in the broadcast receiving device 230.

The device status supervision unit 246 monitors the status of the other devices connected to the first and second networks 190, 191. For example, the device status supervision unit 246 monitors the status of the video recording and reproducing device 150, which is connected to the first network 190, by sending it specific packets defined in, e.g., the UPnP standard and receiving its responses. The device status supervision unit 246 decides that the video recording and reproducing device 150 is in the process of starting up when, for example, the receiving processing unit 249 receives interface screen data indicating that the video recording and reproducing device 150 is in the process of starting up from the video recording and reproducing device 150 via the first communication section 240a, or receives other information indicating that the video recording and reproducing device 150 is in the process of starting up.

The device management unit 247 manages the video recording and reproducing device 150 according to the information obtained by the device status supervision unit 246, as follows.

For example, when the video recording and reproducing device 150 cannot provide its own user interface, the device management unit 247 causes the transfer processing unit 248 to generate surrogate interface screen data to receive commands input by the user by use of the screen control information stored in the screen control information storage unit 244, and causes the transfer processing unit 248 to send the screen data to the remote control device 170. The device management unit 247 causes the receiving processing unit 249 to load bitmap data included in the screen data on the frame storage unit 235 and causes the output section 132 to display the user interface by use of the bitmap data. The device management unit 247 then obtains events that occurred in the user interface from the transfer processing unit 248 or receiving processing unit 249 and causes temporary information storage unit 245 to store such received events in chronological order as event occurrence information. Upon the completion of the start-up process of the video recording and reproducing device 150, the device management unit 247 refers to the stored event occurrence information and causes the receiving processing unit 249 to transfer the events in chronological order.

When the video recording and reproducing device 150 is able to provide its own user interface and the receiving processing unit 249 receives interface screen data from the video recording and reproducing device 150 through the first communication section 240a, the device management unit 247 receives the screen data from the receiving processing unit 249 and causes the transfer processing unit 248 to transfer the received screen data to the remote control device 170 through the second communication section 240b. The device management unit 247 causes the receiving processing unit 249 to load bitmap data included in the screen data on the frame storage unit 235 and causes the output section 132 to display a user interface according to the bitmap data. The device management unit 247 causes the receiving processing unit 249 to transfer events input through this user interface to the video recording and reproducing device 150 through the first communication section 240a.

The device management unit 247 also acquires screen control information from the video recording and reproducing device 150. This process is similar to the process carried out by the device management unit 118 in the first embodiment.

On command from the device management unit 247, the transfer processing unit 248 uses the screen control information stored in the screen control information storage unit 244 to generate, for example, the screen data for the user interface by which the video recording and reproducing device 150 receives command input from the user after the completion of its start-up process. The transfer processing unit 248 also sends the generated screen data to the remote control device 170 through the second communication section 240b. When the transfer processing unit 248 receives an event from the remote control device 170 through the second communication section 240b, it passes the event to the device management unit 247. Then the transfer processing unit 248 refers to the screen control information, and if the received event causes a screen transition, it generates the screen data of the successor screen and sends the generated screen data to the remote control device 170 through the second communication section 240b.

When the receiving processing unit 249 receives screen data from the video recording and reproducing device 150 through the first communication section 240a, it passes the received screen data to the device management unit 247 and loads bitmap data included in the screen data on the frame storage unit 235. Then the receiving processing unit 249 causes the output section 132 to display the user interface by use of the bitmap data loaded on the frame storage unit 235. When an event is generated by input, through the input section 133, of an operation executed by the user on the user interface displayed by the output section 132, the receiving processing unit 249 sends the generated event to the video recording and reproducing device 150 through the first communication section 240a. On command from the device management unit 247, the receiving processing unit 249 sends the event passed from the device management unit 247 to the video recording and reproducing device 150 via the first communication section 240a.

The first communication section 240a transmits information to and receives information from the first network 190.

The second communication section 240b transmits information to and receives information from the second network 191.

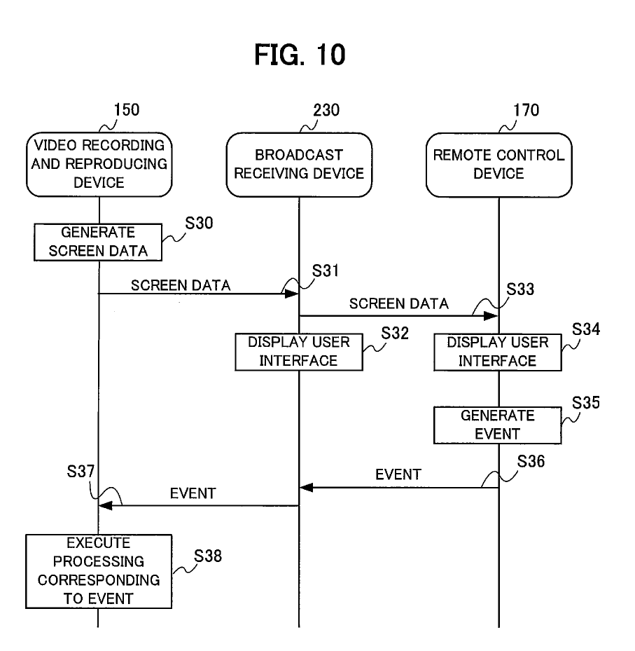

FIG. 10 illustrates an exemplary processing sequence in the network system 200. The sequence shown in FIG. 10 assumes that the broadcast receiving device 230, video recording and reproducing device 150, and remote control device 170 have all been activated and are ready to operate.

In the video recording and reproducing device 150, from the bitmap data and other information stored in the storage section 153 in FIG. 4, the transfer processing unit 156 generates interface screen data for receiving command input from the user (step S30 in FIG. 10). The transfer processing unit 156 sends the generated screen data to the broadcast receiving device 230 through the communication section 158 (step S31).

In the broadcast receiving device 230, the receiving processing unit 249 in the control section 238 receives the screen data through the first communication section 240a. The receiving processing unit 249 passes the screen data to the device management unit 247 and loads bitmap data included in the screen data on the frame storage unit 235. The receiving processing unit 249 causes the output section 132 to display the user interface by use of the bitmap data loaded on the frame storage unit 235 (step S32).

The device management unit 247 in the broadcast receiving device 230 issues a command to the transfer processing unit 248 to transfer the screen data received from the receiving processing unit 249. The receiving processing unit 249 responds by transferring the received screen data to the remote control device 170 through the second communication section 240b (step S33).

In the remote control device 170 (FIG. 5), the receiving processing unit 178 in the control section 176 receives the screen data from the communication section 180. The receiving processing unit 178 loads the bitmap data included in the screen data on the frame storage unit 174. The receiving processing unit 178 causes the display section 171 to display the user interface by use of the bitmap data loaded on the frame storage unit 174 (step S34 in FIG. 10).

When the user performs an input operation through the input section 172 in the remote control device 170 and an event is thereby generated (step S35) in the user interface displayed by the display section 171, the receiving processing unit 178 sends the generated event to the broadcast receiving device 230 through the communication section 180 (step S36).

In the broadcast receiving device 230, the device management unit 247 receives the event from the transfer processing unit 248 and issues a command to the receiving processing unit 249 to transfer the event. The receiving processing unit 249 responds by transferring the event to the video recording and reproducing device 150 through the first communication section 240a (step S37).

In the video recording and reproducing device 150, the transfer processing unit 156 in the control section 154 receives the event from the communication section 158, and performs processing corresponding to the event (step S38).

The sequence described above shows an exemplary case in which the user uses the remote control device 170 to generate an event, but the user may use the broadcast receiving device 230 to generate an event. In that case, the receiving processing unit 249 in the broadcast receiving device 230 sends the generated event to the video recording and reproducing device 150 through the first communication section 240a.

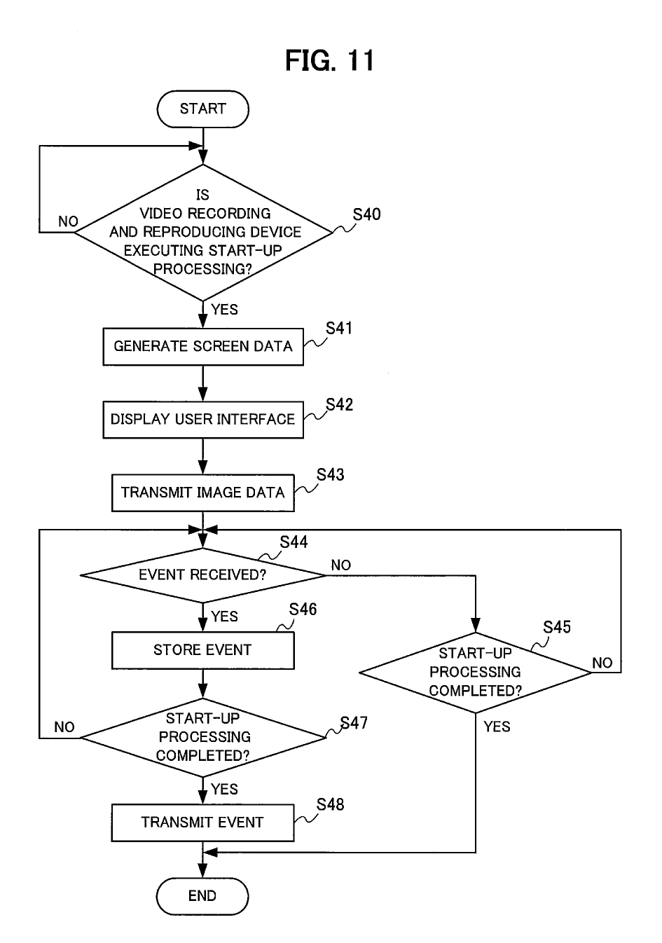

The operation of the broadcast receiving device 230 when the video recording and reproducing device 150 is unable to provide its own user interface will now be described with reference to the flowchart in FIG. 11. FIG. 11 assumes that the video recording and reproducing device 150 is unable to provide its own user interface because it is currently executing start-up processing.

The device status supervision unit 246 in the broadcast receiving device 230 monitors the status of the video recording and reproducing device 150. When the device status supervision unit 246 decides that the video recording and reproducing device 150 is executing start-up processing (Yes in step S40), the device management unit 247 proceeds to step S41.

In step S41, in response to a command from the device management unit 247, the transfer processing unit 248 generates interface screen data that the video recording and reproducing device 150 uses to accept command input from the user. The screen data may represent, for example, the user interface that the video recording and reproducing device 150 displays immediately after it has completed start-up processing.

In response to another command from the device management unit 247, the receiving processing unit 249 loads bitmap data included in the screen data generated in step S41 on the frame storage unit 235. Then the receiving processing unit 249 causes the output section 132 to display the user interface by use of the bitmap data that have been loaded on the frame storage unit 235 (step S42).

The transfer processing unit 248 sends the screen data generated in step S41 to the remote control device 170 through the second communication section 240b (step S43).

The device management unit 247 checks whether or not it has received an event (step S44). In this embodiment, the event is received by the receiving processing unit 249 from the input section 133 or by the transfer processing unit 248 through the second communication section 240b. When the device management unit 247 has not received an event (No in step S44), it proceeds to step S45; when it has received an event (Yes in step S44), it proceeds to step S46.

In step S45, the device management unit 247 refers to the monitoring results in the device status supervision unit 246 to check whether the start-up of the video recording and reproducing device 150 has been completed or not. If the start-up is completed (Yes in step S45), the process ends; if the start-up is not completed (No in step S45), that is, if the video recording and reproducing device 150 is still executing start-up processing, the process returns to step S44.

In step S46, the device management unit 247 causes the temporary information storage unit 245 to store events received in step S44 in chronological order as event occurrence information.

Next, the device management unit 247 refers to the monitoring results in the device status supervision unit 246 to check whether the start-up of the video recording and reproducing device 150 has been completed or not (step S47). If the start-up is completed (Yes in step S47), the process proceeds to step S48; if the start-up is not completed (No in step S47), that is, if the video recording and reproducing device 150 is still executing start-up processing, the process returns to step S44. The video recording and reproducing device 150 becomes capable of providing its own user interface when the start-up is completed.

In step S48, the device management unit 247 refers to the event occurrence information stored in the temporary information storage unit 245 and causes the receiving processing unit 249 to send the events to the video recording and reproducing device 150 in chronological order through the first communication section 240a.

As described above, according to this embodiment, when the video recording and reproducing device 150 is unable to provide its own user interface, the broadcast receiving device 230 provides a surrogate user interface for the video recording and reproducing device 150, thereby enabling the user to perform operations even before the video recording and reproducing device 150 has finished starting up.

When the broadcast receiving device 230 in the second embodiment is powered off or powered down, if power continues to be supplied only to the storage section 234, control section 238, first communication section 240a, and second communication section 240b, or if these components are left in a state from which they can restart quickly, a user interface can be promptly generated and displayed on the remote control device 170. Accordingly, if these units are implemented in an embedded CPU board of the type used in embedded systems, the embedded CPU board should be of the low power type or fast activation type. In this regard, from the aspect of hardware configuration, it is significant that this embodiment can be implemented as an embedded system using any of numerous commercially available CPU boards without alteration. These CPU boards have a wide variety of specifications, and since the programs to be executed by the CPU do not impose a heavy processing load, a CPU board that satisfies requirements for lower power consumption, faster activation, and so on can be selected and employed.

In the first and second embodiments, for operations such as recording a program at a preset time, an electronic program guide (EPG) or the like may have to be displayed. In that case, the device management unit 118 in the network control device 110 and the device management unit 247 in the broadcast receiving device 230 are preferably capable of acquiring the necessary data independently and generating a user interface based on the acquired data. For example, the first network 190 may be connected to a router providing a connection to the Internet to enable the device management unit 118 or 247 to download the necessary data from the Internet through the first communication section 122 or 240a.

Similarly, although the second communication section 123 in the network control device 110 and the second communication section 240b in the broadcast receiving device 230 can be implemented by use of wireless NICs, they may also be implemented by use of wireless access points. Implementation by wireless access points enables simultaneous control of a plurality of mobile terminals, and wider support for wireless connections.

In the embodiments described above, the first network 190 is wired and the second network 191 is wireless, but both networks may be wired, or both may be wireless. In particular, all devices may be interconnected by a single wireless network to eliminate the need for cabling and simplify the task of system setup.

The above embodiments take the case in which the video recording and reproducing device 150 is executing start-up processing as an example of a state in which the video recording and reproducing device 150 is unable to provide its own user interface, but there are other cases as well. For example, the video recording and reproducing device 150 may be in the powered-off state, or in a low-power standby mode.

Those skilled in the art will recognize that further variations are possible within the scope of the invention, which is defined in the appended claims.

What is claimed is:

1. A network control device comprising:
a screen control information storage unit for storing screen control information including user interface image data for operation of a user-operable device;
a communication section for transmitting information to and receiving information from one or more networks;
a transfer processing unit for performing a first transmitting process for transmitting the user interface image data, via the communication section, to a display device connected to the one of the one or more networks and performing a first receiving process for receiving, via the communication section, from the display device, one or more events occurring in a user interface based on the user interface image data; and
a receiving processing unit for performing a first transfer process for transferring the received events via the communication section to the user-operable device.

2. The network control device of claim 1, further comprising a device status supervision unit for supervising the user-operable device and deciding whether the user-operable device is able to provide its own user interface, wherein:
when the device status supervision unit decides that the user-operable device is unable to provide its own user interface, the transfer processing unit performs the first transmitting process and the first receiving process, after which the receiving processing unit performs the first transfer process.

3. The network control device of claim 2, further comprising a device management unit for receiving the events that the transfer processing unit received in the first receiving process and storing the received events in the screen control information storage unit as event occurrence information in chronological order, wherein:
in the first transfer process, the receiving processing unit transfers the events to the user-operable device according to the event occurrence information, in chronological order, when the device status supervision unit decides that the user-operable device is able to provide its own user interface.

4. The network control device of claim 1, wherein:
the receiving processing unit also performs a second receiving process for receiving the user interface image data from the user-operable device via the communication section;
the transfer processing unit also performs a second transmitting process for transmitting the user interface image data received in the second receiving process to the display device and performs a third receiving process for receiving, from the display device, one or more events occurring in the user interface based on the user interface image data transmitted in the second transmitting process; and
the receiving processing unit performs a second transfer process for transferring the events received in the third receiving process to the user-operable device.

5. The network control device of claim 1, wherein:
the screen control information further includes event information concerning events occurring in the user interface and transition information representing interface screen transitions that occur in response to the events; and
upon receiving an event in the first receiving process, the transfer processing unit uses the transition information in the screen control information to identify successor user interface image data to be displayed in response to the received event in the first receiving process and transmits the successor user interface image data via the communication section to the display device.

6. The network control device of claim 1, wherein one of the one or more networks is connected to the Internet, the network control device further comprising a device management unit for obtaining information needed for configuring the user interface from the Internet.

7. The network control device of claim 1, wherein the user interface image data are bitmap data.

8. The network control device of claim 1, wherein:
the user-operable device is a video recoding and reproducing device that reads audio data and video data from a storage medium and reproduces a video picture and sound; and
the display device is a broadcast receiving device that outputs the video picture and sound reproduced by the video recoding and reproducing device.

9. The network control device of claim 1, wherein:
the user-operable device is a video recoding and reproducing device that reads audio data and video data from a storage medium and reproduces a video picture and sound; and
the display device is a mobile device having a display section and an input section for input of user operations.

10. The network control device of claim 9, wherein:
the one or more networks include a first network and a second network;
the communication section includes a first communication section for sending information to and receiving information from the first network and a second communication section for sending information to and receiving information from the second network;
the video recording and reproducing device is connected to the first network; and
the mobile terminal is connected to the second network.

11. The network control device of claim 10, wherein the first network is a wired network and the second network is a wireless network.

12. The network control device of claim 1, wherein the one or more networks are a wireless network.

13. A display device, comprising:
a screen control information storage unit for storing screen control information including user interface image data for operating a user-operable device;
a communication section for transmitting information to and receiving information from a network;
an output section for displaying images on a screen;
an input section for receiving input of user operations; and
a receiving processing unit for performing a display and transfer process by using the output section to display a user interface based on the user interface image data and using the communication section to transfer one or more events to the user-operable device, the one or more events being generated by reception, through the input section, of input of user operations responsive to the user interface.

14. The display device of claim 13, further comprising a device status supervision unit for supervising the user-operable device and deciding whether the user-operable device is able to provide its own user interface, wherein:
the receiving processing unit performs the display and transfer process when the device status supervision unit decides that the user-operable device is unable to provide its own user interface.

15. The display device of claim 14, further comprising a device management unit for receiving the one or more events and storing the one or more events in the screen control information storage unit as event occurrence information in chronological order, wherein:
in the display and transfer process, the receiving processing unit transfers the one or more events to the user-operable device according to the event occurrence information in chronological order when the device status supervision unit decides that the user-operable device is able to provide its own user interface.

16. The display device of claim 13, further comprising a transfer processing unit for performing a first transmitting process for transmitting the user interface image data to another display device connected to the network via the communication section and performing a first receiving process for receiving, from the another display device, one or more events occurring in response to a user interface, based on the user interface image data transmitted in the first transmitting process, displayed by the another display device, wherein:
the receiving processing unit also performs a first transfer process for transferring the one or more events received in the first receiving process to the user-operable device via the communication section.

17. The display device of claim 16, further comprising a device status supervision unit for supervising the user-operable device and deciding whether the user-operable device is able to provide its own user interface, wherein:
when the device status supervision unit decides that the user-operable device is unable to provide its own user interface, the transfer processing unit performs the first transmitting process and the first receiving process, after which the receiving processing unit performs the first transfer process.

18. The display device of claim 17, further comprising a device management unit for receiving the one or more events received in the first receiving process and storing the one or more events received in the first receiving process in the screen control information storage unit as event occurrence information in chronological order, wherein:
in the first transfer process, the receiving processing unit transfers the one or more events stored in the screen control information storage unit to the user-operable device according to the event occurrence information in chronological order when the device status supervision unit decides that the user-operable device is able to provide its own user interface.

19. The display device of claim 16, wherein:
the receiving processing unit also performs a second receiving process for receiving user interface image data from the user-operable device via the communication section;
the transfer processing unit also performs a second transmitting process for transmitting the user interface image data received in the second receiving process to the another display device and performs a third receiving process for receiving, from the another display device, one or more events occurring by user input responsive to the user interface image data transmitted in the second transmitting process; and
the receiving processing unit performs a second transfer process for transferring the one or more events received in the third receiving process to the user-operable device.

20. A method of controlling a user-operable device and a display device connected to a network, the method comprising:
transmitting a user interface image data for operation of the user-operable device to the display device;
receiving, from the display device, one or more events occurring in a user interface based on the user interface image data; and
transferring the received events to the user-operable device.
